(19) United States
(12) Patent Application Publication
(10) Pub. No.: US 2008/0148030 A1
(43) Pub. Date: Jun. 19, 2008

(54) Method and System for Configuring Electronic Communication Device

(75) Inventor: Glen P. Goffin, Dublin, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/610,834

(22) Filed: Dec. 14, 2006

(51) Int. Cl. G06F 9/00

(52) U.S. Cl. 713/1

(57) ABSTRACT

A method for configuring an electronic communication device (100) is disclosed. The method automatically configures the electronic communication device for a user. The method includes determining (304) an identity of the user. The method further compiles a user profile automatically (306), as a function of the manner in which the user operates the electronic communication device. The compiled user profile is stored (308) in the electronic communication device. Further, based on the stored user profile, the method automatically configures (310) the electronic communication device, without intervention of the user.

### FIELD OF THE INVENTION

The invention relates in general to the field of electronic communication devices, and more particularly, to a method and system for configuring an electronic communication device.

### BACKGROUND OF THE INVENTION

Electronic communication devices such as mobile phones, video phones, personal digital assistants (PDA), laptop computers and smart phones are becoming increasingly popular. Electronic communication devices, in addition to enabling communication, can be used to store important information. Typically, electronic communication devices may set various features based on user preferences. For example, a user may customize various features such as, ring tones, wallpaper, themes, dialing numbers, and electronic device alerts, based on user preferences. The user has to customize each feature separately. This may be a time consuming and tiresome activity for the user.

Currently, electronic communication devices may store the preferences of a set of features in a profile. Once each of the set of features is customized in the profile, the profile is stored in an electronic communication device. Thereafter, every time a user needs to customize the set of features, the user may select a stored profile, and hence the corresponding set of features would be set automatically at the electronic communication device.

However, when there are multiple users of an electronic communication device, each user has to select his profile from the stored profiles manually. If an electronic communication device stores a large number of profiles, the activity of selecting a profile becomes even more time consuming.

### SUMMARY

In an embodiment, a method for configuring an electronic communication device is provided. The method includes determining the identity of a user of the electronic communication device. On detecting the identity, a user profile is compiled automatically as a function of the manner in which the user operates the electronic communication device. The compiled user profile is stored in the electronic communication device. Based on the stored user profile, the electronic communication device is automatically configured, without intervention of the user.

In another embodiment, an electronic communication device capable of automatically configuring a user profile (or features) is provided. The electronic communication device includes an input device, a first memory and a user profiling module. The input device automatically captures an identity of a user of the electronic communication device. The first memory associated with the electronic communication device stores a user profile. The user profiling module learns the user profile, while the user is using the electronic communication device and stores the learned user profile in the first memory. Further, the user profiling module automatically configures the electronic communication device for the user, based on the learned user profile.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary electronic communication device, in accordance with an embodiment of the present invention;

FIG. 2 illustrates a block diagram of an electronic communication device, in accordance with an embodiment of the present invention; and

FIG. 3 is a flow diagram illustrating a method for configuring an electronic communication, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help to improve an understanding of embodiments of the present invention.

### DETAILED DESCRIPTION

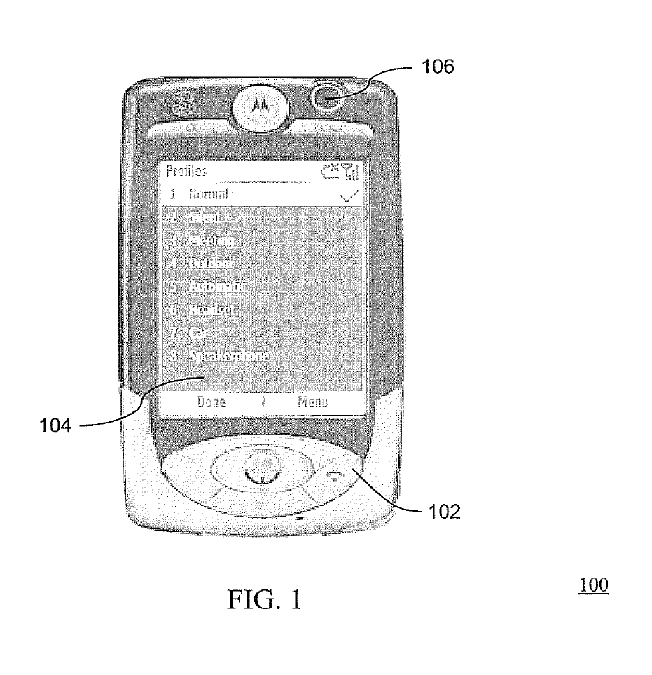

FIG. 1 illustrates an exemplary electronic communication device 100, in accordance with an embodiment of the present invention. Examples of the electronic communication device 100 include, but are not limited to, a mobile phone, a video phone, a smart phone, a laptop computer, a desktop computer and a personal digital assistant (PDA). The electronic communication device 100 has a keypad 102, a display 104 and a camera 106. A user can select different options displayed on the display 104 to configure various features (and profile) in the electronic communication device 100, through an input device such as the keypad 102. For example, a feature of a mobile phone may include a ring tone, a wallpaper, a theme, dialing numbers, and an alert of an electronic device.

A user can customize his profile using the keypad 102. For example, if the user selects a silent profile the electronic communication device will automatically reduce the volume of the ring tone and keypad tones. Further, a sensor such as the camera 106 can capture the identity of the user to enable identification of the user. Though the electronic communication device 100 is shown to include a camera 106, the electronic communication device 100 may include any other biometric sensor to identify the user. In an embodiment, the sensor can be a RFID reader. The RFID reader will identify a user by a unique RFID tag associated with each user of the electronic communication device 100. In this embodiment, while using the electronic communication device 100, the user may put the unique RFID tag in front of the RFID reader. Thereby, the electronic communication device 100 can identify the user by reading the information from the unique RFID tag. Although the invention is described with reference to biometric sensors, it should be noted that any other types of sensors can also be used to detect the identity of a user of an electronic communication device.

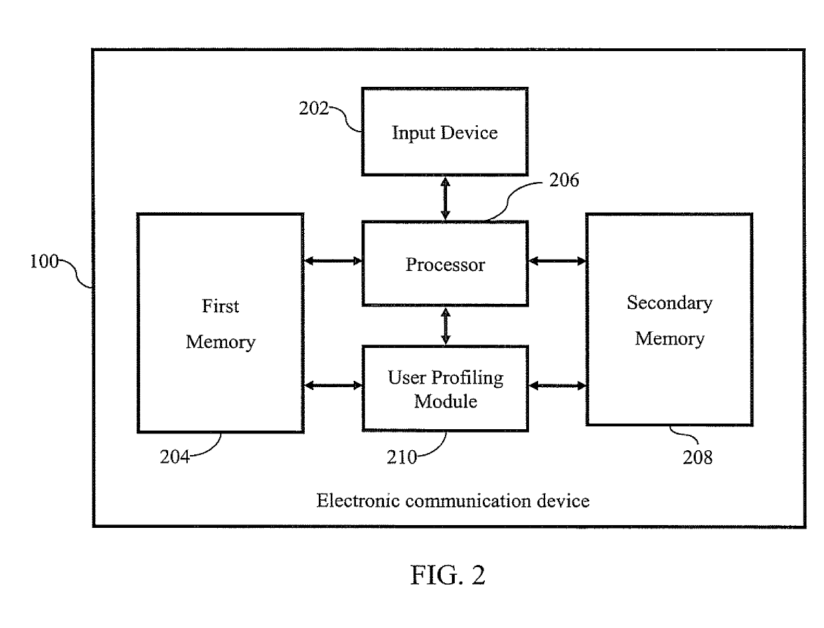

FIG. 2 illustrates a block diagram of the electronic communication device 100, in accordance with an embodiment of the present invention. The electronic communication device 100 automatically compiles a user profile in the electronic communication device 100, while a user is using the electronic communication device 100. For example, the electronic communication device 100 can be a video mobile phone that is associated with a plurality of users. When there is a plurality of users for a device, the video mobile phone compiles a user profile for each of the plurality of users. The electronic communication device 100 includes an input device 202, a first memory 204, a processor 206, a second memory 208, and a user profiling module 210.

The input device 202, such as a camera or any other biometric sensor, automatically captures an identity of the user, while the user is using the electronic communication device 100. Examples of the input device 202 includes, but are not limited to, a camera, a sensor, a voice recorder, a finger print scanner, retina identifier, a touch screen sensor and a motion tracker. The first memory 204 is adapted to store a user profile. In one embodiment, the first memory 204 stores a plurality of user profiles corresponding to a plurality of users of electronic communication device.

The user profiling module 210 learns the user profile, while the user is using the electronic communication device 100. For example, if a user changes the ring tone (or the phone book entries), the profile is automatically updated. The next time that user uses electronic communication device 100, the updated user profile will be configured to reflect the changed ring tone. The user profiling module 210 stores the learned user profile in first memory 204. Further, the user profiling module 210 automatically configures the electronic communication device 100 for the user, based on the learned user profile. In one embodiment, the user profiling module 210 verifies the captured identity of the user with the plurality of user identities stored in the second memory 208. Each user identity stored in the second memory 208 is associated with a profile stored in the first memory 204. The user profiling module 210, after verifying the captured identity, configures the profile of the user the electronic communication device. For example, when the identity of a user is verified, the features (or profile) corresponding to the identity are automatically configured at the electronic communication device 100.

In one embodiment, the user profiling module 210 learns the user preferences by obtaining information regarding dialing preferences, interface preferences, preferred caller, ring tone preferences, display preferences and graphics preferences. Further, the user profiling module 210 stores the obtained information as the compiled user's profile in the first memory 204, based on the verification of the captured identity. In one embodiment, user lighting preferences such as background lighting and the color of lighting may be stored in a user profile.

User identities are stored in second memory 208. If the captured identity does not correspond to one of the plurality of user identities stored in the second memory 208, a new user identity is created. Further, the user profiling module 210 stores the compiled user profile in the first memory 204 such that the stored user profile is associated with the corresponding stored user identity.

If the captured identity of the user matches one of the stored identities, the user profiling module 210 retrieves the corresponding user profile from first memory 204. In one embodiment, the user profiling module 210 updates the retrieved user profile in real-time, as the user uses the electronic communication device 100. Thereafter, the user profiling module 210 configures the stored user profile in the electronic communication device 100. In another embodiment, first memory 204 and second memory 208 may be linked in order to communicate with or exchange stored identities and user profiles. In another embodiment, the functionalities of the first memory 204 and the second memory 208 may be performed using a single storage device.

The user profiling module 210 may be implemented as one or more physical devices that are coupled to the processor 206 through a communication channel, including for chips within the device or attached dongles. Alternatively, the user profiling module 210 may be represented by one or more software applications (or even a combination of software and hardware, e.g., using application specific integrated circuits (ASIC)), where the software is loaded from a storage medium, (e.g., a magnetic or optical drive or diskette) and operated by the processor 206 in the memory 204, 208 of electronic communication device 100. As such, the user profiling module 210 (including associated data structures) of the present invention may be stored on a computer readable medium, e.g., RAM memory, magnetic or optical drive or diskette and the like.

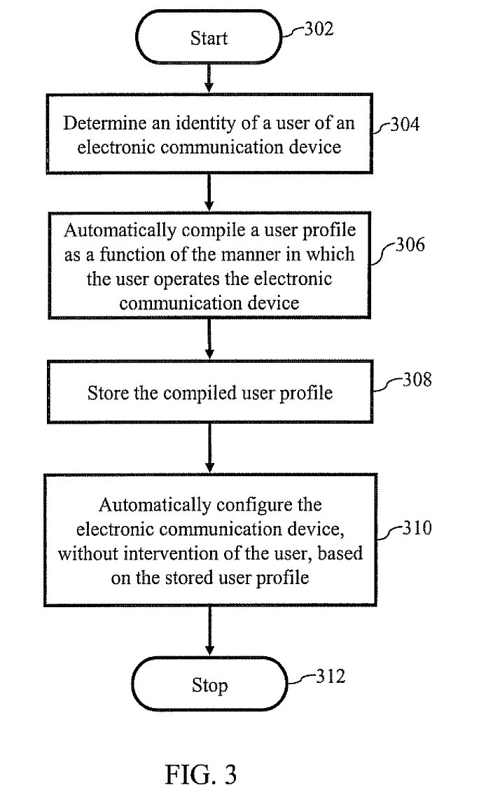

FIG. 3 is a flow diagram illustrating a method for configuring an electronic communication, in accordance with an embodiment of the present invention. The method shows various steps involved in configuring the electronic communication device. Moreover, the method can comprise fewer or greater number of steps than shown in FIG. 3. To describe the flow diagram, reference will be made to FIG. 1 and FIG. 2, although it will be understood by a person ordinary skilled in the art that the flow diagram can be implemented with reference to any other suitable embodiment of the present invention.

The method is initiated at step 302. At step 304, an identity of a user of the electronic communication device is determined. The identity is captured using the input device, when the user is using the electronic communication device 100. In an embodiment, the input device 202, for example a camera 106, captures an identity of a user, when the user is using the electronic communication device 100. In an embodiment, the user is recognized based on a biometric recognition. The biometric recognition of the user can be a fingerprints recognition, a face recognition, a facial thermo-grams recognition, a signature recognition, a gait recognition, a hand geometry recognition, a iris recognition, a retina recognition, a palm-print recognition, a writing recognition, an action recognitions or a voiceprint recognition. For example, in voice recognition, the input device captures user's voice patterns. Similarly, in writing recognition, the input device captures the writing style. In another example, a sensor can be a touch screen sensor that recognizes a user by the actions/quirks performed by the user. An example of action/quirk can be tapping the touch screen sensor for a particular number of times, before using the electronic communication device 100. For example, a visually impaired user can be recognized by the electronic communication device 100 if he/she taps the touch screen sensor quickly, for say, three times.

At step 306, a user profile is automatically compiled as a function of the manner in which the user operates the electronic communication device 100. The user profile can be automatically compiled by the user profiling module 210. In one embodiment, for compiling the user profile, the user profiling module 210 can continuously learn user preferences as soon as the user changes configuration of any feature (or profile) such as a wallpaper, and a ring tone. The user profiling module 210 learns user preferences by obtaining information regarding user's dialing preferences, interface preferences, preferred caller preferences, dialer tone preferences, display preferences, voice pattern preferences, writing preferences and graphic preferences of the user. In another embodiment, the user profile can be compiled and stored by obtaining information of the user lighting preferences.

Further, at step 308, the user profiling module 210 stores the compiled user profiles. In one embodiment, the user profiling module 210 stores the compiled user profiles in the first memory 204. The plurality of user profiles is stored in the first memory 204. In one embodiment, each identity of the plurality of stored identities corresponds to a stored user profile.

In another embodiment, the user profiling module 210 stores the plurality of compiled user profiles in the first memory 204. If the captured identity does not correspond to one of the plurality of user identities stored in the second memory 208, a new user identity is created. Further, the user profiling module 210 stores the compiled user profile in the first memory 204 such that the stored user profile is associated with the corresponding stored user identity.

If the captured identity of the user matches one of the stored identities, the user profiling module 210 retrieves the corresponding user profile from first memory 204. Further, the user profiling module 210 updates the retrieved user profile with the learned user preferences and stores the updated user profile in the first memory 204.

Thereafter, at step 310, the electronic communication device 100 is automatically configured for the user. For example, when a mobile phone identifies a user, the preferred caller list of the user can be automatically configured. The preferred caller list may include most frequently dialed numbers by the user. In another example, the preferred caller list may be a list of the numbers that are always answered by the user. The electronic communication device 100 can also be configured by setting user interfaces preferences such as a graphic display, a color scheme, a text font, a skin, a screensaver, a speed dialing assignment, a voice dialing assignment and a recorded template. Similarly, a volume level, a ring tone and an alert can also be learned and automatically configured when the user uses the electronic communication device 100 subsequently. Thereafter, the method terminates at step 312.

For clarity, the method is illustrated with reference to an example. A mobile phone captures the identity of a user using bio metric sensor such as a fingerprint recognition device in the mobile phone. The fingerprint recognition device can capture fingerprints of the user when the user picks up the mobile phone. The fingerprints are compared with the stored fingerprints. If the fingerprints are verified, user preferences of features (or the profile) are automatically configured. Further, the mobile phone continuously monitors the changes made by the user in his preferences. The changes are automatically updated in the stored profile.

If the fingerprints of the user do not match with the stored fingerprints, i.e., for a new user, the fingerprints and the preferences regarding the features (or the profile) are stored. The stored profile can be automatically configured, when the user subsequently uses the mobile phone.

Various embodiments, as described above, provide a method and system for configuring an electronic communication device. The method automatically configures different user profile in the electronic communication device for each user, based on the preferences of the user. Further, the profile can also be updated automatically based on the real time user preferences. Automatic configuring and updating of profile will require no manual effort and is less time-consuming. Moreover, the electronic communication device will continue learning the user preferences and will update the user profile on frequent basis.

It will be appreciated that the method and system for an electronic communication device described herein may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of a method to enable users to view a broadcasted media stream differently. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one of ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one of ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for configuring an electronic communication device for a user, the method comprising:
determining the identity of a user of the electronic communication device;
automatically compiling a user profile as a function of a manner in which the user operates the electronic communication device;
storing the compiled user profile; and
automatically configuring the electronic communication device, without intervention of the user, based on the stored user profile.

2. The method as recited in claim 1, wherein the electronic communication device comprises a video communication device.

3. The method as recited in claim 2, wherein compiling the user profile comprises obtaining information of at least the user lighting preferences.

4. The method as recited in claim 1, wherein the electronic communication device comprises a video communication device.

5. The method as recited in claim 1, wherein identifying the user comprises recognizing the user based on biometric recognition.

6. The method as recited in claim 1, wherein compiling the user profile comprises obtaining information of at least one of dialing preferences, interface display preferences, preferred caller preferences, dialer tone preferences, ring tone preferences, alert preferences, display color scheme preferences, volume level preferences, display preferences, voice pattern preferences, internet service preferences, writing pattern preferences, and graphic preferences.

7. The method as recited in claim 1, wherein determining the identity of a user of the electronic communication device comprises comparing the determined identity of the user to a plurality of stored user identities.

8. The method as recited in claim 6 wherein each of the stored user identities corresponds to a stored user profile.

9. The method as recited in claim 7, wherein configuring the electronic communication device comprises:
selecting a particular stored user profile based upon the determined user identity corresponding to one of the plurality of stored user identities; and
setting the user preferences of the electronic communication device based upon the selected particular stored user profile and the present manner in which the user operates the electronic communication device.

10. The method as recited in claim 7, wherein configuring the electronic communication device comprises:
when the identity of the user is not verified, adding the determined user identity to the plurality of stored user identities
if the determined user identity does not correspond to one of the plurality of stored user identities; and
storing a compiled user profile for the added user so that the profile is associated with the identity of the added user.

11. An electronic communication device performing automatic configuration of a user profile, the electronic communication device comprising:
an input device capable of automatically capturing an identity of a user;
a first memory adapted for storing a user profile; and
a user profiling module for:
learning a user profile while the user is using the electronic communication device;
storing the learned user profile in the first memory; and
automatically configuring the electronic communication device for the user based on the learned user profile.

12. The electronic communication device as recited in claim 11, wherein the electronic communication device comprises a video communication device.

13. The electronic communication device as recited in claim 12, wherein the user preferences comprise at least user lighting preferences.

14. The electronic communication device as recited in claim 11, wherein the input device comprises at least one biometric sensor.

15. The electronic communication device as recited in claim 11, wherein the user preferences comprises at least one of dialing preferences, user interface preferences, preferred caller preferences, dialer tone preferences, ring tone preferences, color scheme preferences, volume level preferences, display preferences, voice pattern preferences, writing pattern preferences, and graphic preferences.

16. The electronic communication device as recited in claim 11, further comprising a second memory adapted to store a plurality of user identities.

17. The electronic communication device as recited in claim 16, wherein each of the plurality of user identities stored in the second memory is associated with a user profile stored in the first memory.

18. The electronic communication device as recited in claim 17, wherein the processor is further adapted to retrieve a particular set of stored user profile from the first memory based upon the captured identity of the user corresponding to one of the user identities stored in the second memory.

19. The electronic communication device as recited in claim 17, wherein the processor is further adapted to store the captured identity in the second memory if the captured identity does not correspond to one of the user identities stored in the second memory; and to store the compiled user profile in the first memory so that the stored user profile is associated with the stored captured identity.
